(19) United States
(12) Patent Application Publication
(10) Pub. No.: US 2007/0166488 A1
(43) Pub. Date: Jul. 19, 2007

(54) Cleaning composite comprising lines of frangibility

(76) Inventors: Susan M. Trefethren, Appleton, WI (US); Jonathan K. Arendt, Appleton, WI (US); Carl G. Rippl, Appleton, WI (US); Michael T. Krebsbach, Appleton, WI (US); Courtney B. De Salvatore, Appleton, WI (US); Sherry H. Hudson, Ellettsville, IN (US)

Correspondence Address: KIMBERLY-CLARK WORLDWIDE, INC., 401 NORTH LAKE STREET, NEENAH, WI, 54956, US

(21) Appl. No.: 11/414,101

(22) Filed: Apr. 28, 2006

Related U.S. Application Data
(60) Provisional application No. 60/761,077, filed on Jan. 19, 2006.

(51) Int. Cl. B31B 45/00; G09F 3/00

(52) U.S. Cl. 428/34.1; 428/43

(57) ABSTRACT

A cleaning composite comprising a foam layer, such as melamine foam, and lines of frangibility in said foam, is disclosed. The lines of frangibility allow a user of the foam to break the foam into two or more pieces for immediate and/or later cleaning of surfaces. The user breaks the foam along one or more lines of frangibility to produce the pieces.

This application claims priority to provisional application Ser. No. 60/761,077 entitled Cleaning Composite Comprising Lines of Frangibility and filed in the U.S. Patent and Trademark Office on Jan. 19, 2006. The entirety of provisional application Ser. No. 60/761,077 is hereby incorporated by reference.

### BACKGROUND

Cleaning applications employ cleaning products, such as towels, in order to remove dirt and other unwanted elements from surfaces. In some instances the cleaning product may be a urethane foam or a cellulose sponge, which may be used in order to wipe a surface clean. The cleaning product may be configured with bristles or grit disposed thereon in order to aid in cleaning.

Cleaning products can be configured to work when in a dry state in order to clean the surface, or may be designed to work in a wet state so that the cleaning product is wet to some degree when cleaning the surface. A detergent may be used with the cleaning product in order to assist in breaking up dirt and other unwanted elements so that the surface may be cleaned. It is sometimes the case that dirt or other unwanted elements cannot be sufficiently removed from a surface even when a cleaning product is properly applied. Applying the cleaning product too aggressively may result in the surface being damaged, and may still not result in the removal of dirt or unwanted elements from the surface. Examples of difficult-to-clean materials include crayon on walls, scuff marks from shoes on floors, permanent magic marker markings on a variety of surfaces such as dry erase boards, stains on porcelain or ceramics including dentures, grease and oil spots on numerous surfaces, hard water spots and soap scum on tile, biofilms on metal and plastic surfaces, mildew and fungus growths on numerous surfaces, and other forms of dirt, grime, or other unwanted elements from various surfaces.

Blocks of melamine foam have been recognized as having useful cleaning properties when wetted with water and rubbed against certain surfaces to be cleaned, and have been marketed in several countries for such purposes. Melamine-based foam has an open-celled, microporous structure. Melamine-based foam is abrasive in that when rubbed across a surface, dirt and other unwanted elements will be removed. Particles of the melamine-based foam may break off due to this abrasive contact. Over time, the melamine-based foam will be worn down due to repeated abrasion with the surface to be cleaned and the unwanted elements present on this surface.

Melamine-based foam may be used to clean a surface when in a wet state. In this regard, the melamine-based foam may be soaked with water to some degree prior to being applied by a user to the surface to be cleaned. A block of melamine-based foam by itself is sometimes used as a cleaning product. In this regard, the user may grasp the block of melamine-based foam, wet the block in water, and then rub the wetted melamine-based foam across a surface to remove dirt and unwanted elements.

Unfortunately, commercially marketed blocks of melamine-based foam suffer from at least one drawback. It does not appear to have been recognized that melamine foam blocks may be configured to employ lines of frangibility such that a user of the melamine foam block can break the block along one or more lines of frangibility into two or more pieces of melamine foam for immediate and/or later use.

### SUMMARY

We have found that a melamine foam block employing lines of frangibility provides a user of the block with the convenience of breaking the initial block into smaller pieces for use in cleaning surfaces. A user of the melamine foam block may select pieces having a size and/or shape best suited for a particular cleaning job.

Various features and advantages of the invention will be set forth in part in the following description.

The present invention provides for a cleaning composite comprising lines of frangibility for use in cleaning a surface through wiping or scrubbing, either in a dry state, in the presence of water, or in the presence of other cleaning agents or other compounds. The lines of frangibility allow a user of the melamine foam block to break the block, along one or more lines of frangibility, into smaller pieces suitable for cleaning.

The composite includes a foam such as an aminoplast foam (e.g., foams made from urea-formaldehyde resins or melamine-formaldehyde resins) or a phenolic foam such as a foam made from phenol-formaldehyde resins, wherein the foam has mechanical properties suitable for contacting and cleaning the surface.

A detailed description of foams made of aminoplasts, i.e., for example, formaldehyde condensation products based on urea, melamine, dicyanodiamide and/or derivatives thereof, are found, for example in Kunststoff-Handbuch, Vol. X, Vieweg-Becker “Duroplaste”, Karl Hanser Verlag, Munich, 1968, pp. 135 et seq., especially 466-475, including the bibliography cited therein. Corresponding information on foams of phenoplasts is found, for example, in Ullmann, Encyklopadie der technischen Chemie, 3rd ed., Vol. 15 (1964), pp. 190-1 including the bibliography mentioned therein.

Further, any aminoplast foam or other rigid or brittle foam disclosed in U.S. Pat. No. 4,125,664, “Shaped Articles of Foam Plastics,” issued Nov. 14, 1978 to H. Giesemann, herein incorporated by reference, may be used to produce the products of the present invention. Other foams believed to be useful within the scope of the present invention include those disclosed in U.S. Pat. No. 4,666,948, “Preparation of Resilient Melamine Foams,” issued May 19, 1987 to Woerner et al.; U.S. Pat. No. 5,234,969, “Cured Phenolic Foams,” issued Aug. 10, 1993 to Clark et al.; U.S. Pat. No. 6,133,332, “Process for Producing Phenolic Resin Foams,” issued Oct. 17, 2000 to T. Shibanuma; and WO 91/14731, “Stable Aminoplast Cellular Foams and Process for Manufacturing Them,” published Oct. 3, 1991 by Mäder et al., all of which are herein incorporated by reference. The latter, WO 91/14731, discloses cellular foams obtained by using an unsaturated, halogenated polyalcohol in a resin precondensate constituent and a dodecylbenzolsulphonic acid partially esterified preferably with a fatty alcohol and a long-chain polyhydric alcohol such as a polyethylene glycol, in a foaming agent hardener constituent.

In one embodiment, the cleaning foam comprises a thermoset foam, and the thermoset components of the cleaning foam may comprise over 50%, over 60%, over 80%, or over 90% of the mass of the foam. Alternatively, the solid polymeric components of the cleaning foam may consist essentially of one or more thermoset materials. In another embodiment, the cleaning foam is substantially free of thermoplastic materials. In another embodiment, the cleaning foam does not comprise more than 50% of any one of a component selected from polyolefin materials, polyurethanes, silicones, and polyesters.

The present invention also provides for a cleaning product that is adapted to clean dirt from a surface. The cleaning product includes a melamine based foam layer or similar brittle foam that is configured for engaging a surface and cleaning the surface. Without wishing to be bound by theory, it is believed that the minute size of the solid fiber-like struts in the foam that define the cells of the foam (e.g., struts generally having a diameter on the order of 5 microns or less, or on the order of 2 microns or less), coupled with a general degree of deformability of the bulk foam, allows the solid material under mild pressure to readily fit into crevices and recesses on a surface that may be filled with dirt or grime. A relatively non-rounded shape of the struts of solid material that define the sides of the open cell foams may also enhance the cleaning efficacy of the material, providing a somewhat knife-like attack on deposits during scrubbing, as opposed to the more gentle abrasive effect one might expect from filaments having substantially cylindrical cross-sections. Further, the relatively hard nature of the solid material is believed to be effective in scraping out the dirt or grime as the foam is moved over the surface. Alternatively, some have speculated that the brittleness of the foam allows small particles with sharp edges to break off when moving in contact with a surface, and that the small particles so formed contribute to the degree of friction and cleaning provided by the foam. The presence of water is generally helpful in the cleaning process, though other chemicals or cleaning agents need not be present (but can be, if desired).

Principles for manufacturing melamine-based foam are well known. Melamine-based foams are currently manufactured by BASF (Ludwigshafen, Germany) under the BASOTECT® brand name. For example, BASOTECT® 2011, with a density of about 0.01 g/cm³, may be used. Blocks of melamine-based foam for cleaning are marketed by Procter & Gamble (Cincinnati, Ohio) under the MR. CLEAN® brand name, and under the CLEENPRO™ name by LEC, Inc. of Tokyo, Japan (several product executions are shown at http://www.users.bigpond.com/jmc.au/CLEENPRO/CLEENPRO-E.htm and http://www.users.bigpond.com/jmc.au/CLEENPRO/CLEENPRO%20Family-E.htm, both printed on Nov. 13, 2003). Melamine-based foam is also marketed for acoustic and thermal insulation by many companies such as American Micro Industries (Chambersburg, Pa.).

Principles for production of melamine-based foam are disclosed by H. Mahnke et al. in EP-B 071 671, published Dec. 17, 1979. According to EP-B 017 671, they are produced by foaming an aqueous solution or dispersion of a melamine-formaldehyde condensation product which comprises an emulsifier (e.g., metal alkyl sulfonates and metal alkylaryl sulfonates such as sodium dodecylbenzene sulfonate), an acidic curing agent, and a blowing agent, such as a C5-C7 hydrocarbon, and curing the melamine-formaldehyde condensate at an elevated temperature. The foams are reported to have the following range of properties:
a density according to DIN 53 420 between 4 and 80 grams per liter (g/l), corresponding to a range of 0.004 g/cc to 0.08 g/cc (though for purposes of the present invention the density can also range from about 0.006 g/cc to about 0.1 g/cc, or other useful ranges);
a thermal conductivity according to DIN 52 612 smaller than 0.06 W/m ° K;
a compression hardness according to DIN 53 577 under 60% penetration, divided by the density, yielding a quotient less than 0.3 (N/cm²)/(g/l), and preferably less than 0.2 (N/cm²)/(g/l), whereby after measurement of compression hardness the thickness of the foam recovers to at least 70% and preferably at least 90% of its original thickness;
an elasticity modulus according to DIN 53 423, divided by the density of the foam, under 0.25 (N/mm²)/(g/l) and preferably under 0.15 (N/mm²)/(g/l);
a bending path at rupture according to DIN 53 423 greater than 6 mm and preferably greater than 12 mm;
a tensile strength according to DIN 53 571 of at least 0.07 N/mm² or preferably at least 0.1 N/mm²; and
by German Standard Specification DIN 4102 they show at least standard flammability resistance and preferably show low flammability.

U.S. Pat. No. 6,503,615, issued Jan. 7, 2003 to Horii et al., discloses a wiping cleaner made from an open-celled foam such as a melamine-based foam, the wiping cleaner having a density of 5 to 50 kg/m3 in accordance with JIS K 6401, a tensile strength of 0.6 to 1.6 kg/cm2 in accordance with JIS K 6301, an elongation at break of 8 to 20% in accordance with JIS K 6301 and a cell number of 80 to 300 cells/25 mm as measured in accordance with JIS K 6402. Melamine-based foams having such mechanical properties can be used within the scope of the present invention.

Related foams are disclosed in U.S. Pat. No. 3,093,600 with agents present to improve the elasticity and tear strength of the foam.

Brittle foams can be made, as described in German publication DE-AS 12 97 331, from phenolic components, urea-based components, or melamine-based components, in aqueous solution with a blowing agent and a hardening catalyst.

The entire disclosure of U.S. Pat. No. 6,608,118 is incorporated by reference herein in its entirety.

Melamine-based foams are also disclosed in British patent GB 1443024, issued Jul. 21, 1976.

The brittle foam may comprise organic or inorganic filler particles, such as from 5% to 30% by weight of a particulate material. Exemplary particulate materials include clays such as kaolin, talc, calcium oxide, calcium carbonate, silica, alumina, zeolites, carbides, quartz, and the like. The fillers can also be fibrous materials, such as wood fibers, papermaking fibers, coconut fibers, milkweed fibers, flax, kenaf, sisal, bagasse, and the like. The particles of fibers added to the foam may be heterogeneously distributed or may be distributed homogeneously.

The foam or a portion thereof may also be impregnated with a material to reinforce or harden the foam, if desired, such as impregnation with water glass or other silicate compounds, as disclosed in U.S. Pat. No. 4,125,664, “Shaped Articles of Foam Plastics,” issued Nov. 14, 1978 to H. Giesemann, herein incorporated by reference. Adhesives, hot melts, cleaning agents, bleaching agents (e.g., peroxides), antimicrobials, and other additives may be impregnated in the foam.

The foam may be molded or shaped into three-dimensional shapes for aesthetic or functional purposes. For example, melamine-based foam may be thermally molded according to the process disclosed in U.S. Pat. No. 6,608,118, “Melamine Molded Foam, Process for Producing the Same, and Wiper,” issued Aug. 19, 2003 to Y. Kosaka et al., herein incorporated by reference, which discloses molding the foam at 210 to 350 C (or, more particularly, from 230° C. to 280° C. or from 240° C. to 270° C.) for 3 minutes or longer to cause plastic deformation under load, wherein the foam is compressed to a thickness of about 1/1.2 to about 1/12 the original thickness, or from about 1/1.5 to about 1/7 of the original thickness. The molded melamine foams can be joined to a urethane sponge layer to form a wipe, according to of Kosaka et al.

As described by Kosaka et al., the melamine-based foam can be produced by blending major starting materials of melamine and formaldehyde, or a precursor thereof, with a blowing agent, a catalyst and an emulsifier, injecting the resultant mixture into a mold, and applying or generating heat (e.g., by irradiation or electromagnetic energy) to cause foaming and curing. The molar ratio of melamine to formaldehyde (i.e., melamine:formaldehyde) for producing the precursor is said to be preferably 1:1.5 to 1:4, or more particularly 1:2 to 1:3.5. The number average molecular weight of the precursor can be from about 200 to about 1,000, or from about 200 to about 400. Formalin, an aqueous solution of formaldehyde, can be used as a formaldehyde source.

As monomers for producing the precursor, according to Kosaka et al., the following monomers may be used in an amount of 50 parts by weight (hereinafter abbreviated as “parts”) or less, particularly 20 parts by weight or less, per 100 parts by weight of the sum of melamine and formaldehyde. Melamine is also known by the chemical name 2,4,6-triamino-1,3,5-triazine. As other monomers corresponding to melamine, there may be used C₁₋₅ alkyl-substituted melamines such as methylolmelamine, methylmethylolmelamine and methylbutylolmelamine, urea, urethane, carbonic acid amides, dicyandiamide, guanidine, sulfurylamides, sulfonic acid amides, aliphatic amines, phenols and the derivatives thereof. As aldehydes, there may be used acetaldehyde, trimethylol acetaldehyde, acrolein, benzaldehyde, furfurol, glyoxal, phthalaldehyde, terephthalaldehyde, and the like.

As the blowing agent, there may be used pentane, trichlorofluoromethane, trichlorotrifluoroethane, etc. As the catalyst, by way of example, formic acid may be used and, as the emulsifier, anionic surfactants such as sodium sulfonate may be used.

The amount of the electromagnetic energy to be irradiated for accelerating the curing reaction of the reaction mixtures can be adjusted to be from about 500 to about 1,000 kW, or from about 600 to 800 kW, in electric power consumption based on 1 kg of an aqueous formaldehyde solution charged in the mold. If the electric power applied is insufficient, there may be insufficient foaming, leading to production of a cured product with a high density. On the other hand, in case when the electric power consumption is excessive, the pressure upon foaming becomes high, leading to significant exhaust flows from the mold and even the possibility of explosion.

Other useful methods for producing melamine-based foam are disclosed in U.S. Pat. No. 5,413,853, “Melamine Resin Foam,” issued May 9, 1995 to Y. Imashiro et al., herein incorporated by reference. According to Imashiro et al., a melamine resin foam can be obtained by coating a hydrophobic component on a known melamine-formaldehyde resin foam body obtained by foaming a resin composition composed mainly of a melamine-formaldehyde condensate and a blowing agent. The components used in the present melamine resin foam can therefore be the same as those conventionally used in production of melamine-formaldehyde resins or their foams, except for the hydrophobic component.

As an example, Imashiro et al. disclose a melamine-formaldehyde condensate obtained by mixing melamine, formalin and paraformaldehyde and reacting them in the presence of an alkali catalyst with heating. The mixing ratio of melamine and formaldehyde can be, for example, 1:3 in terms of molar ratio.

The melamine-formaldehyde condensate can have a viscosity of about 1,000-100,000 cP, more specifically 5,000-15,000 cP and can have a pH of 8-9.

As the blowing agent, a straight-chain alkyl hydrocarbon such as pentane or hexane is disclosed.

In order to obtain a homogeneous foam, the resin composition composed mainly of a melamine-formaldehyde condensate and a blowing agent may contain an emulsifier. Such an emulsifier includes, for example, metal alkylsulfonates and metal alkylarylsulfonates.

The resin composition may further contain a curing agent in order to cure the foamed resin composition. Such a curing agent includes, for example, acidic curing agents such as formic acid, hydrochloric acid, sulfuric acid and oxalic acid.

The foam disclosed by Imashiro et al. can be obtained by adding as necessary an emulsifier, a curing agent and further a filler, etc. to the resin composition composed mainly of a melamine-formaldehyde condensate and a blowing agent, heat-treating the resulting mixture at a temperature equal to or higher than the boiling point of the blowing agent to give rise to foaming, and curing the resulting foam.

In another embodiment, the foam material may comprise a melamine-based foam having an isocyanate component (isocyanate-based polymers are generally understood to include polyurethanes, polyureas, polyisocyanurates and mixtures thereof). Such foams can be made according to U.S. Pat. No. 5,436,278, “Melamine Resin Foam, Process for Production Thereof and Melamine/Formaldehyde Condensate,” issued Jul. 25, 1995 to Imashiro et al., herein incorporated by reference, which discloses a process for producing a melamine resin foam comprising a melamine/formaldehyde condensate, a blowing agent and an isocyanate. One embodiment includes the production of a melamine resin foam obtained by reacting melamine and formaldehyde in the presence of a silane coupling agent. The isocyanate used in U.S. Pat. No. 5,436,278 can be exemplified by CR 200 (a trademark of polymeric-4,4′-diphenylmethanediisocyanate, produced by Mitsui Toatsu Chemicals, Inc.) and Sumidur E211, E212 and L (trademarks of MDI type prepolymers, produced by Sumitomo Bayer Urethane Co., Ltd). One example therein comprises 100 parts by weight of melamine/formaldehyde condensate (76% concentration), 6.3 parts sodium dodecylbenzenesulfonate (30% concentration), 7.6 parts pentane, 9.5 parts ammonium chloride, 2.7 parts formic acid, and 7.6 parts CR 200. A mixture of these components was placed in a mold and foamed at 1 00° C., yielding a material with a density of 26.8 kg/m³ (0.0268 g/cm³), a compression stress of 0.23 kgf/cm², and a compression strain of 2.7%. In general, the melamine-based foams of U.S. Pat. No. 5,436,278 typically had a density of 25-100 kg/m³, a compression strain by JIS K 7220 of 2.7%-4.2% (this is said to be improved by about 40%-130% over the 1.9% value of conventional fragile melamine foams), and a thermal conductivity measured between 10° C. to 55° C. of 0.005 kcal/m-h-° C. or less (this is far smaller than 0.01 kcal/m-h-° C. which is said to be the value of conventional fragile foam). Other foams comprising melamine and isocyanates are disclosed in WO 99/23160, “Composition and Method for Insulating Foam,” published May 14, 1999 by Sufi, the U.S. equivalent of which (application U.S. Pat. No. 9,823,864) is herein incorporated by reference.

In another embodiment, a melamine-based foam may be used that is produced according to WO 0/226872, “Hydrophilic, Open-Cell, Elastic Foams with a Melamine/Formaldehyde Resin Base, Production Thereof and use thereof in Hygiene Products,” published Apr. 4, 2002 by Baumgartl and Herfert. Such foams have been tempered at elevated temperature to improve their suitability for use as absorbent articles in proximity to the human body. During or after the tempering process, further treatment with at least one polymer is disclosed, the polymer containing primary and/or secondary amino groups and having a molar mass of at least 300, although this polymer treatment may be skipped, if desired, when the foams of WO 0/226872 are applied to the present invention. Such foams are said to have a specific surface area determined by BET of at least 0.5 m²/g. Exemplary phenolic foams include the dry floral foams made by Oasis Floral Products (Kent, Ohio) and also the water-absorbent open-celled brittle phenolic foams manufactured by Aspac Floral Foam Company Ltd. (Kowloon, HongKong), partially described at http://www.aspachk.com/v9/aspac/why aspac.html. Open-cell phenolic foams can be made from the phenolic resins of PA Resins (Malmo, Sweden) combined with suitable hardeners (e.g., an organic sulfonic acid) and emulsifiers with a blowing agent such as pentane. Phenolic resins may include resole resins or novolac resins, for example, such as the Bakelite® Resin 1743 PS (Bakelite AG, Iserlohn-Letmathe, Germany) which is used for floral foams.

Any of the preceding versions of melamine foam may be modified to comprise one or more lines of frangibility so that the foam block-whatever the initial shape or volume—may be broken into two or more pieces for immediate or later use. The lines of frangibility may be introduced to the melamine foam in a variety of ways, as is described below. For example, a line of pins having a certain diameter, and spaced equidistantly apart from one another, may be pressed through some or all of the thickness of a melamine foam block (see, e.g., FIGS. 1 and 2 for representative versions of blocks comprising lines of frangibility, with the lines of frangibility comprising a series of such perforations or holes in the melamine foam block). Lines of frangibility may comprise other modifications to the foam block, so long as the line of frangibility is, in effect, a line of weakness along which a user of the block may readily separate the melamine block into pieces of melamine foam.

### BRIEF DESCRIPTION OF THE DRAWINGS

FIG. 1 is a view of one representative version of a cleaning composite of the present invention.

FIG. 2 is a view of another representative version of a cleaning composite of the present invention.

FIG. 3 is a view of another representative version of a cleaning composite of the present invention.

### DEFINITIONS

Within the context of this specification, each term or phrase below includes the following meaning or meanings:

“Attach” and its derivatives refer to the joining, adhering, connecting, bonding, sewing together, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Bond” and its derivatives refer to the joining, adhering, connecting, attaching, sewing together, or the like, of two elements. Two elements will be considered to be bonded together when they are bonded directly to one another or indirectly to one another, such as when each is directly bonded to intermediate elements. “Bond” and its derivatives include permanent, releasable, or refastenable bonding.

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

“Disposable” refers to articles that are designed to be discarded after a limited use rather than being laundered or otherwise restored for reuse.

The terms “disposed on,” “disposed along,” “disposed with,” or “disposed toward” and variations thereof are intended to mean that one element can be integral with another element, or that one element can be a separate structure bonded to or placed with or placed near another element.

“Elastic,” “elasticized,” “elasticity,” and “elastomeric” mean that property of a material or composite by virtue of which it tends to recover its original size and shape after removal of a force causing a deformation. Suitably, an elastic material or composite can be elongated by at least 25 percent (to 125 percent) of its relaxed length and will recover, upon release of the applied force, at least 40 percent of its elongation.

“Extensible” refers to a material or composite that is capable of extension or deformation without breaking, but does not substantially recover its original size and shape after removal of a force causing the extension or deformation. Suitably, an extensible material or composite can be elongated by at least 25 percent (to 125 percent) of its relaxed length.

“Layer” when used in the singular can have the dual meaning of a single element or a plurality of elements.

These terms may be defined with additional language in the remaining portions of the specification.

### DETAILED DESCRIPTION

Reference will now be made in detail to embodiments of the invention, one or more examples of which are illustrated in the drawings. Each example is provided by way of explanation of the invention, and is not meant as a limitation of the invention. For example, features illustrated or described as part of one embodiment can be used with another embodiment to yield still a third embodiment. It is intended that the present invention include these and other modifications and variations.

It is to be understood that the ranges and limits mentioned herein include all ranges located within, and also all values located under or above the prescribed limits. For instance, a range from about 100 to 200 also includes ranges from 110 to 150, 170 to 190, and 153 to 162. Further, a limit of up to about 7 also includes a limit of up to about 5, up to 3, and up to about 4.5.

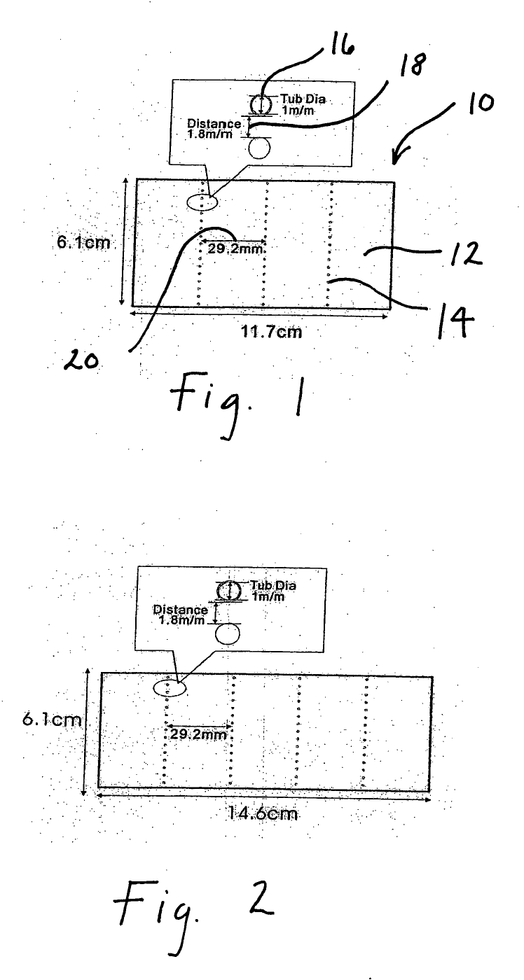

The present invention provides for a cleaning product which may be a cleaning composite 10 as shown in FIG. 1. The cleaning composite 10 includes a foam 12 such as a melamine-based foam. The foam 12 generally has an open celled structure that when moved over a surface is capable of effectively cleaning dirt and other unwanted elements from the surface.

FIG. 1 depicts cleaning composite 10 as possessing a generally rectangular shape. In this representative version of the invention, the block has a length of 11.7 centimeters and a width of 6.1 centimeters. As is noted below, a cleaning composite of the present invention may possess a variety of shapes, including, for example, a generally square shape or a generally oval shape. Also, some or all of the perimeter of the cleaning composite may be shaped to facilitate gripping by the human hand (e.g., by having an undulating perimeter that allows a user to place one or more of his or her fingers into depressions or grooves at the perimeter).

It should be noted that one or both surfaces of cleaning composite 10 may be contoured. In some versions of the invention, a surface may be contoured in such a way that the resulting surface is adapted to better conform to the palm-side surface of a user's hand.

The relative thicknesses of the layers depicted in the exemplary embodiment of FIG. 1 can vary.

The cleaning composite 10 may be configured such that the foam 12 is a relatively thin layer. For instance, the foam may be on the order of from about 2 millimeters to about 8 millimeters in thickness. Other exemplary embodiments of the present invention exists in which the foam 12 may have a varying thickness, for instance being 1 millimeter thick at certain portions, and being 10 millimeters thick at other portions. As such, the present invention includes various embodiments in which the foam 12 has a uniform thickness throughout, and also a varying thickness throughout. Additionally, the present invention includes exemplary embodiments where the foam 12 is less than 60 millimeters in thickness. In other versions, the thickness of the foam 12 is less than 50 millimeters in thickness. In still other versions, the thickness of the foam 12 is less than 40 millimeters in thickness. In other exemplary embodiments the thickness of the foam 12 is less than 30 millimeters in thickness. Other exemplary versions of the foam 12 have a thickness less than 20 millimeters in thickness. Still further exemplary embodiments exist in which the foam 12 is less than 15 millimeters in thickness, less than 10 millimeters in thickness, and less than 5 millimeters in thickness.

Additional exemplary embodiments of the present invention exist in which the foam 12 is from about 1 millimeter to about 15 millimeters in thickness.

The foam 12 may be free from plastic deformation. In another aspect, the melamine based foam 12 used in the present application may be capable of regaining a part of or all of its original shape and size after being subjected to some degree of deformation.

The foam 12 has been modified to include lines of frangibility 14. In this instance, the lines comprise individual holes through the entire thickness of the foam block. The individual holes 16 have a diameter of 1 millimeter and are spaced apart by a distance 18 of 1.8 millimeter. The lines of frangibility are spaced apart by a distance 20 of 29.2 mm.

The lines of frangibility may be introduced to the foam in other ways and in other arrangements, of course, so long as the lines of frangibility create a line of weakness along which the foam will separate. For example, rather than circular holes, openings of other shapes may be introduced to the foam. Pins having a square, octagonal, triangular, or other shape may be pressed through the foam to create one or more lines of frangibility. Furthermore, the cross-sectional area of the individual pins can be changed, and the distance between the individual pins can be modified, when introducing lines of frangibility to the foam. The cross-sectional area, inter-pin distance, and depth of penetration may be selected to affect the force that a user needs to apply when separating the foam along the line of frangibility.

If circular in shape, the openings may have a diameter of about 0.5 or greater; of about 1 mm or greater; of about 2 mm or greater; or of about 3 mm or greater. Generally the openings—if circular—will have a diameter less than about 5 mm. If the openings are of other shapes (e.g., square, triangular, etc.), then the cross-sectional area of such openings may be selected to correspond to the cross-sectional areas associated with the circular openings recited in the preceding sentence.

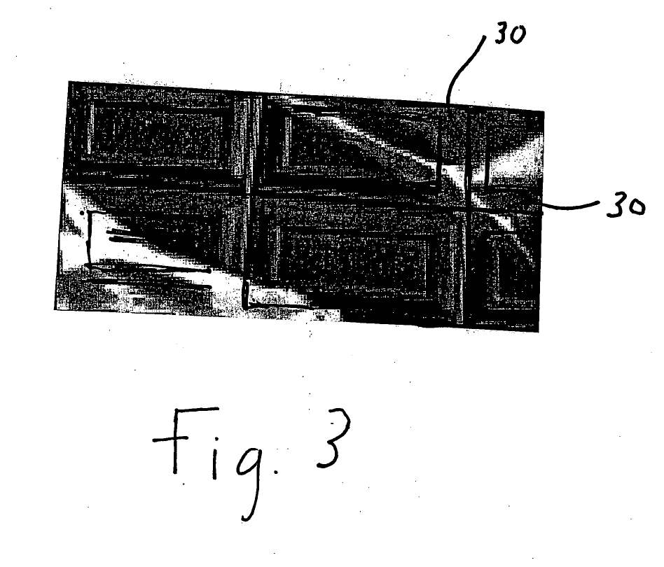

The placement of two or more lines of frangibility may also be changed to produce individual foam pieces of differing sizes and shapes once the initial foam piece or block is separated along a line of frangibility. For example, FIG. 2 depicts another representative version of a cleaning composite comprising lines of frangibility (in this case a rectangular block having a length of 14.6 centimeters, a width of 6.1 centimeters, and 4 lines of frangibility spaced apart by a distance of 29.2 millimeters—with each line of frangibility comprising circular openings having a diameter of 1 millimeter, and spaced apart by a distance of 1.8 millimeter). Or, for example, a cleaning block may have lines of frangibility that divide the block into two rows of rectangular-shaped pieces, with each row having one common line of frangibility placed centrally along one of the dimensions of the initial block (e.g., akin to the two rows of rectangular-shaped pieces of chocolate in a Hershey's®-brand chocolate bar).

As noted above, individual openings need not penetrate through the entire thickness of the block. Also, rather than individual openings, the foam can be modified to have indentations in the surface of the block, thereby creating a line of frangibility along which a user may separate the block into pieces. Again, as noted earlier, a foam piece may be modified to include indentations or scoring in its surface to produce a line of frangibility (see, e.g., FIG. 3, which depicts a portion of a possible foam block comprising lines of frangibility that define the outer perimeter of individual rectangular pieces, each of which has a contoured surface, as might be found, for example, in a Hershey's®-brand chocolate bar; the lines of frangibility 30 are indentations in the foam).

The lines of frangibility may be introduced in any way, so long as a line of weakness is created in the foam block such that the block may be broken along the line of weakness to create pieces. As noted above, differing arrangements of holes, openings, or perforations may be introduced into the block through some or all of its thickness. This may be done when the foam is produced by the foam's manufacturer, or during some subsequent converting step. For example, indentations, scoring, or other such depressions may be molded or pressed into the foam using heat, pressure, ultrasonic energy, or some combination thereof. A press can be used to push individual pins or the like through part or all of the foam. Or the foam can be cut, sawn, or otherwise processed in this manner to produce indentations or scoring.

As noted above, it is to be understood that the cleaning composite 10 of the present invention is not limited to a particular shape. As such, the cleaning composite 10 may be square, round, or cylindrical in accordance with various exemplary embodiments. Further, the cleaning composite 10 may have hollow elements that are configured in order to receive fingers, hands, cleaning agents, or inserts in accordance with various exemplary embodiments of the present invention.

The cleaning composite 10 (see representative version in FIG. 1) may also be configured in some embodiments such that the “melamine based foam” is a non-melamine foam that contains melamine powder. Other representative embodiments that may be adapted to comprise lines of frangibility are disclosed in U.S. patent application Ser. No. 10/744,238, filed on Dec. 22, 2003, and entitled “Multi Purpose Cleaning Product Including a Foam and a Web”; U.S. patent application Ser. No. 11/103,910, filed on 11 Apr. 2005 and entitled “Cleaning Composite”; both of which are hereby incorporated by reference in their entirety in a manner consistent herewith. Some versions of the invention may include a second layer or component attached to at least a portion of the foam (e.g., a nonwoven layer). Any second layer, e.g., a nonwoven layer, that overlaps a line of frangibility in the foam will be perforated or otherwise include openings such that the nonwoven layer is adapted to separate along with the foam along said line of frangibility.

The manufacturer or distributor of a cleaning composite of the present invention may fashion messages, statements, or copy to be transmitted to a purchaser, consumer, or user of said cleaning composite. Such messages, statements, or copy may be fashioned to help facilitate or establish an association in the mind of a user of the composite between a cleaning composite of the present invention, or use thereof, and one or more mental states, psychological states, or states of well being. The communication, statements, or copy may include various alphanumeric strings, including, for example: clean, fresh, mountain, country, zest, sea, sky, health, hygiene, water, waterfall, moisture, moisturize, scent, convenient, single, child, environment, disposable, derivatives or combinations thereof, or other such words or states. In one embodiment, the communication, statements, or copy associate a cleaning composite of the present invention and less waste, increased efficiency, increased effectiveness, or some combination thereof. In another embodiment, the communication, statements, or copy associate a cleaning composite of the present invention and disposability. In another embodiment, the communication, statements, or copy associate a cleaning composite of the present invention and a registered or common-law trademark of the seller, manufacturer, and/or distributor of the appliance. For example, a statement could be disposed in or on a container containing a cleaning composite of the present invention that associates the cleaning composite with the logo or brand name of Mr. Clean®, Pledge®, Mr. Proper®, Flash®, AJAX®, Fabuloso®, Cif®, Clorox®, Pine-Sol®, Lysol®, Scrubbing Bubbles®, Fantastic®, 409®, Tilex®, Scrubby®, Comet®, Swiffer™, Viva®, Kleenex®, Scott®, Febreze®, and combinations thereof. The statement could associate a cleaning composite of the present invention with other cleaning formulations or cleaning substrates like those referenced in the preceding sentence. In another embodiment, the communication, statements, or copy associate a cleaning composite of the present invention and a the concept of a user being able to select a size for use by separating the cleaning composite into separate pieces.

Messages, copy, statements, and/or alphanumeric strings like those referred to above may be used either alone, adjacent to, or in combination with, other alphanumeric strings. The communication, statements, message, or copy could take the form of (i.e., be embodied in a tangible medium such as) a newspaper advertisement, a television advertisement, a radio or other audio advertisement, items mailed directly to addressees, items emailed to addresses, Internet Web pages or other such postings, free standing inserts, coupons, various promotions (e.g., trade promotions), co-promotions with other companies, copy and the like, boxes and packages containing the product (in this case an appliance of the present invention), and other such forms of disseminating information to consumers or potential consumers. Other exemplary versions of such communications, statements, messages, and/or copy may be found in, for example, U.S. Pat. Nos. 6,612,846 and 6,896,521, both entitled “Method for Displaying Toilet Training Materials and Display Kiosk Using Same”; co-pending U.S. application Ser. No. 10/831,476, entitled “Method of Enunciating a Pre-Recorded Message Related to Toilet Training in Response to a Contact”; co-pending U.S. application Ser. No. 10/956,763, entitled “Method of Manufacturing and Method of Marketing Gender-Specific Absorbent Articles Having Liquid-Handling Properties Tailored to Each Gender”; each of which is incorporated by reference in their entirety in a manner consistent herewith. For example, a message embodied in a tangible medium could associate a cleaning composite of the present invention with the logo or brand name of Mr. Clean®, Pledge®, Mr. Proper®, Flash®, AJAX®, Fabuloso®, Cif®, Clorox®, Pine-Sol®, Lysol®, Scrubbing Bubbles®, Fantastic®, 409®, Tilex®, Scrubby®, Comet®, Swiffer™, Viva®, Kleenex®, Scott®, Febreze®, and combinations thereof. A message embodied in a tangible medium could associate a cleaning composite of the present invention with other cleaning formulations or cleaning substrates like those referenced in the preceding sentence.

It should be noted that when associating statements, copy, messages, or other communications with a package (e.g., by printing text, images, symbols, graphics, color(s), or the like on the package; or by placing printed instructions in the package; or by associating or attaching such instructions, a coupon, or other materials to the package; or the like) containing cleaning composite of the present invention, the materials of construction of said package may be selected to reduce, impede, or eliminate the passage of water or water vapor through at least a portion of the package. Furthermore, the materials of construction of said package may be selected to minimize or impede the passage of light through said package, including minimizing or impeding the passage of electromagnetic waves of a selected wavelength or wavelengths.

As noted above, some embodiments of the present invention may comprise a cleaning composition, agent, some combination thereof, and the like. Such compositions may contain water. Therefore packages, containers, envelopes, bags, and the like that reduce, minimize, or eliminate the evaporation or transmission of water or water vapor from cleaning composites contained therein may be beneficial. Furthermore, cleaning composites may be individually wrapped in containers, packets, envelopes, bags, wrappers, or the like that inhibit, reduce, or eliminate the passage or transmission of water or water vapor from cleaning composites contained therein. For purposes of this application, “packages,” “containers,” “envelopes,” “bags,” “packets,” and the like are interchangeable in the sense that they refer to any material adapted to enclose and hold either individual cleaning composites (as in, for example, an individual packet containing a single cleaning composite), or a plurality of cleaning composites (as in a flexible bag made of film or plastic container containing a plurality of cleaning composites, whether or not each of the individual cleaning composites are enclosed and held in a separate material—such as individual packets).

In some embodiments of the present invention, a package will contain not only one or more cleaning composites of the present invention, but other products. In one embodiment, a cleaning composite of the present invention is sold, transferred, distributed, or marketed with a cleaning tool. It should be noted that such combinations may be marketed and packaged as described in the preceding paragraphs. It should also be noted that statements on packages, messages embodied in tangible media, and packages like those described in this paragraph may be associated with the brand name or logo of a private-label brand (meaning that a product or article of manufacture, like a cleaning composite of the present invention, is made by one company for sale under the logo or brand name of another company—often the logo or brand name of a retailer or distributor).

It should be understood that the present invention includes various modifications that can be made to the embodiments of the cleaning composite as described herein as come within the scope of the appended claims and their equivalent

1. A cleaning composite comprising foam having one or more lines of frangibility.

2. The cleaning composite of claim 1 wherein the lines of frangibility comprise a plurality of openings in said foam.

3. The cleaning composite of claim 1 wherein the foam has a thickness, and the openings penetrate the entire thickness of the foam.

4. The cleaning composite of claim 1 wherein the lines of frangibility comprise one or more indentations in said foam.

5. A package comprising:
a container, and
a cleaning composite of claim 1 contained in said container.

6. The package of claim 5 further comprising a statement disposed in or on said container, and wherein the statement associates the cleaning composite with a user selecting a size of the foam for use.

7. The package of claim 5 further comprising a statement disposed in or on said package, and wherein the statement associates the cleaning composite with a logo and/or brand name of a cleaning formulation, cleaning substrate, or both.

8. The package of claim 7 further comprising a statement disposed in or on said package, and wherein the statement associates the cleaning composite of claim 1 with a logo and/or brand name selected from the group consisting of Mr. Clean®, Pledge®, Mr. Proper®, Flash®, AJAX®, Fabuloso®, Cif®, Clorox®, Pine-Sol®, Lysol®, Scrubbing Bubbles®, Fantastic®, 409®, Tilex®, Scrubby®, Comet®, Swiffer™, Viva®, Kleenex®, Scott®, Febreze®, and combinations thereof.

9. A message embodied in a tangible medium and adapted to be transmitted to consumers, wherein the message refers to the cleaning composite of claim 1 and a logo and/or brand name selected from the group consisting of Mr. Clean®, Pledge®, Mr. Proper®, Flash®, AJAX®, Fabuloso®, Cif®, Clorox®, Pine-Sol®, Lysol®, Scrubbing Bubbles®, Fantastic®, 409®, Tilex®, Scrubby®, Comet®, Swiffer™, Viva®, Kleenex®, Scott®, Febreze®, and combinations thereof.
